(19) United States
(12) Patent Application Publication
(10) Pub. No.: US 2007/0174421 A1
(43) Pub. Date: Jul. 26, 2007

(54) System and method for generating screensavers

(76) Inventor: Stephen F. Dunham, Encinitas, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/339,924

(22) Filed: Jan. 25, 2006

(51) Int. Cl. G06F 15/16

(52) U.S. Cl. 709/217

(57) ABSTRACT

A system and method of generating screensavers. In one embodiment, a client may upload a plurality of images to a screensaver server. The server creates a screensaver application program using the uploaded images. In one embodiment, the screensaver application program compresses the uploaded images. The screensaver transmits the generated screensaver program to the user for installation on the user's computer.

### BACKGROUND OF THE INVENTION

1. Field of the Invention

The field of the invention relates to images. More particularly, the field relates to systems and methods for automatically creating screen saver programs.

2. Description of the Related Technology

The usage of electronic images, e.g., digital images and video, has become more and more prevalent. In view of this, there has developed increased needs for new ways for owners of these electronic images to view such images and transmit such images to their friends.

### SUMMARY OF THE INVENTION

One embodiment comprise a method. The method comprises: receiving, via network, a plurality of electronic images; generating a screensaver application program that is configured to display the received electronic images; and transmitting, via the network, the generated screensaver application program to a provider of the electronic images.

Another embodiment comprises a system. The system comprises: an electronic device configured receive, via a network, a plurality of electronic images, the electronic device being further configured to generate a screensaver application program that is configured to display the received electronic images, and the electronic device being further configured to transmit, via the network, the generated screensaver application program to a provider of the electronic images.

Yet another embodiment comprises a system. The system comprises: means for receiving, via network, a plurality of electronic images; means for generating a screensaver application program that is configured to display the received electronic images; and means for transmitting, via the network, the generated screensaver application program to a provider of the electronic images.

### BRIEF DESCRIPTION OF THE DRAWINGS

FIG. 1 is a block diagram illustrating a screensaver distribution system.

FIG. 2 is a flowchart illustrating a process of generating and transmitting a screensaver application program via the screensaver distribution program of FIG. 1.

### DETAILED DESCRIPTION OF THE EMBODIMENTS OF THE INVENTION

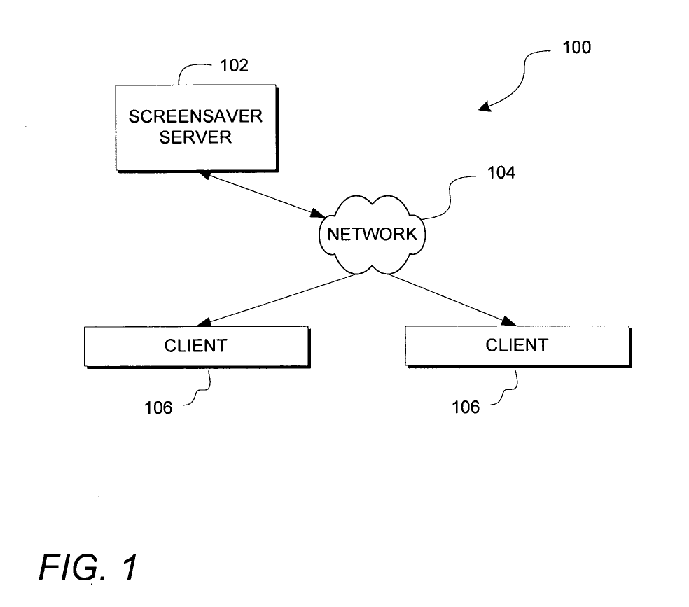

FIG. 1 illustrates a block diagram of a screensaver distribution system 100. The system includes at least one screensaver server 102, a network 104, and a plurality of client computers 106. As will be described in further detail below, using the screensaver server 102, a user of one of the client computers 106 can create customized a screen saver application program for execution on the user's computer. The screen saver application program may be used in connection with various operating systems such as: UNIX, LINUX, Disk Operating System (DOS), OS/2, PalmOS, VxWorks, Windows 3.X, Windows 95, Windows 98, Windows NT, Windows CE, and Windows XP. The client computers 102 can include any type of computerized device, such as non-limiting examples: a desktop computer, a set top computer, a laptop, a cell phone, kiosk, or a wireless electronic photo frame. As illustration, if the client computer is a kiosk, it could be placed at a photo store, mall, or other public place. A consumer could use the kiosk to create and transmit a screensaver application program as further described below.

The network 104 may include any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, set-top, or any other desired type of configuration. As used herein, the network 104 includes network variations such as the public Internet, a private network within the Internet, a secure network within the Internet, a private network, a public network, a value-added network, an intranet, and the like.

The screensaver server 102 includes a screensaver generator program that may be written in any programming language such as, for example, C, C++, BASIC, Visual Basic, Pascal, Ada, Java, HTML, XML, or FORTRAN, and executed on an operating system. C, C++, BASIC, Visual Basic, Pascal, Ada, Java, HTML, XML and FORTRAN are industry standard programming languages for which many commercial compilers can be used to create executable code. The screensaver server 102 hosts the client application which allows users to create accounts, upload and manage images and collections of images and submit screensavers to the screensaver generator program in order to build the screensaver application for download. The screensaver generator program may produce the screensaver executable immediately or schedule the executable for later generation in order to manage server load. The screensaver server 102 also manages the payment process and administrative functions. The screensaver server 102 may run any of a variety of web programming languages including, but not limited to ColdFusion, Active Server Pages, ASP.NET, or PHP.

The screensaver server 102 contains a plurality of web pages that are viewable by a user at the client computer 104. The web pages are virtual documents that each have embedded links which link portions of the virtual pages to other virtual pages and other data. A user can traverse the virtual pages and download data by selecting with a mouse or other input device a predetermined portion of the virtual page.

In one embodiment, the screensaver server 102 includes the following: a “home” page, a “start here” page, a “create a screensaver” page, a “return login” page, a “support page”, and a “contact” page. The home page may include sales and marketing information about the screensaver products and servers that are provided by the screensaver server 102. Each of the other above-listed pages is accessible via links from the home page.

The start here page is used to start creating a screensaver. When a user accesses this page, he is provided general information regarding using the screensaver server 102 to create a custom screensaver. The return login page allows user who have previously ordered from the site to access his screensaver. The support web page provides a form for support which allows customers to ask questions and request support from the administrator. The contact page provides information to enable the users contact the administrator and ask questions or make comments.

The create screensaver page provides graphical controls links to allow a user to upload video images, view screensaver samples, and order the screensaver. In one embodiment, an image resizing tool is used to control the size and of the images uploaded to keep them within the preset standards determined by the website administrator allowing the screensavers to be optimized for online delivery to the client's computer.

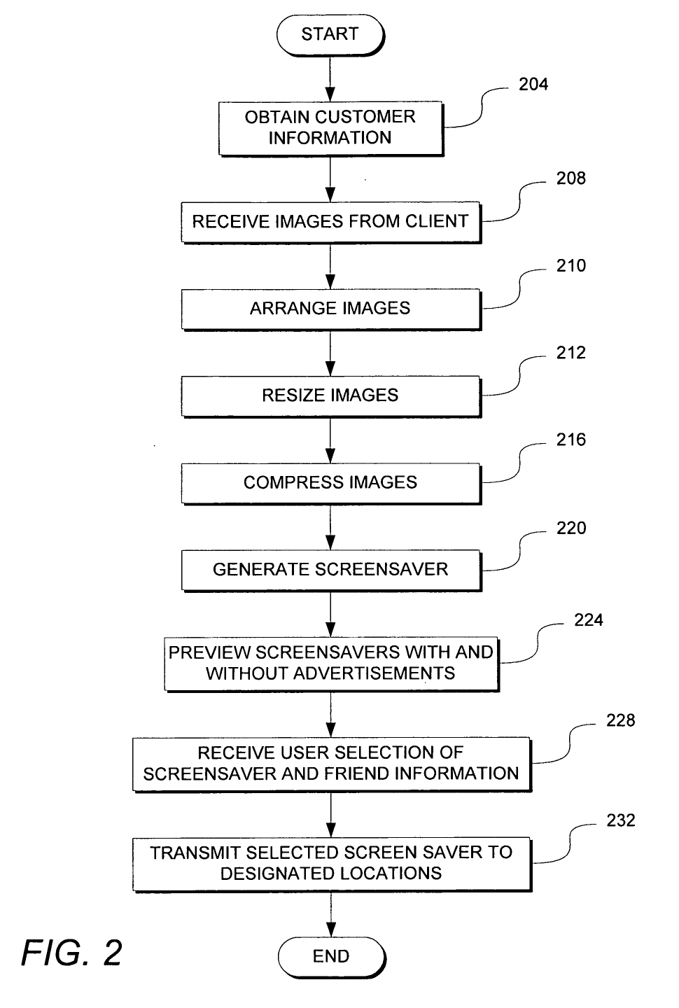

FIG. 2 is a flowchart illustrating a process that is performed, in one embodiment, by the screensaver server 102. Depending on the embodiment, additional steps may be entered, others removed, and the ordering of the steps rearranged. Starting at a step 204, the screen generator 102 obtains customer information, e.g., name, address, password, etc.

Continuing to a step 208, the screensaver server 102 receives the “images” that are provided by one of the client computer 106. As non-limiting examples, the “images” can include data in one of the following data formats: a template, a static file, a Joint Photographic Experts Group (JPEG) file, an animated GIF, a HypterText Markup Layout page, a .wav file, a Macromedia flash file, or a video file.

In one embodiment, the screensaver server 102 maintains a library of images that are provided by the user. In one embodiment, a user of the client computer 106 can limit access to the library to selected individuals, group of individuals, or accounts. Furthermore, in one embodiment, the screensaver server 102 maintains a plurality of libraries of images that are accessible for all or selected users.

Next, at a step 210, a user selects one or more images from any of the image libraries from which that the user has access. Proceeding to a step 212, the selected images may be resized. In one embodiment, the images are automatically resized by the screensaver server 102 so fill as much of a display as is possible. In one embodiment, the user may also optionally manually resize the images. Furthermore, in one embodiment, the user may also emboss one or more of the images with provided text at a location, font, and font size, specified by the user.

Next, at a step 216, the selected images are compressed by the screensaver server 102. Compressing the images makes the resulting screensaver program that is transmitted to the user computer smaller than it would be otherwise and thereby allowing the screensaver program to be more readily re-transmitted by the user, if desired. In one embodiment, each of the images is resized to 1024 pixels wide or 768 pixels tall, depending on the orientation of the image.

Continuing to a step 220, the screensaver server 102 creates two packages. In one embodiment, each of the two packages includes an executable program and selected processed images of steps 210, 212, and 216. One of the two packages also includes images of advertisements that have been inserted into the selected images. The other of the two packages does not contain these advertisements. In one embodiment, a user can obtain for free the package that has the advertisements but will have to pay for the package that does not contain the advertisements. In the package that has the advertisements, the executable program in the package is configured to intermittently display one of the advertisements. In one embodiment, the executable program periodically retrieves from a predefined location new advertisements for display, the predefined location being accessible via the network 104. In one embodiment, each of the packages are self-extracting executables—that is, after executing it, it extracts the screen saver application program and accompanying images.

In one embodiment, the screensaver program allows a user to designate one of the images as desktop background. In another embodiment, the generated screensaver includes musical or audio elements. The musical or audio elements may be integrated into the package or the package may identify a music server that can periodically or alternatively transmit such audio to the client computers. The music server can include music from an audio source, such as XM satellite radio.

Moving to a step 224, the user can preview the screensaver packages. In this embodiment, the user will see a sample rotation of the screensaver program illustrated by representations of on-screen monitors built in Macromedia Flash which is designed to dynamically load the images through XML files and preview versions of the images created by the program.

Next at a step 228, the user selects one of the packages. If the user desires to obtain a package without advertisements, the screensaver server 102 requests billing information. After ordering, in one embodiment, the user informed that they will be emailed when the screensaver has been created and is ready for pickup. In another embodiment, the selected email package is automatically emailed to the user.

In one embodiment, the user may purchase a subscription to certain types or a category of images. In this embodiment, additional images may be periodically transmitted to the client computers for inclusion or replacement of images already provided. This feature may be beneficially used for providing voyeuristic types of images. Alternatively, a whole new package may periodically emailed or otherwise transmitted to the client computers 106.

Also, as step 228, the screensaver server 102 requests the user to provide the email address of friends and family. The screensaver server 102 automatically notifies via email the friends that a screensaver package is available for purchase (without ads) or for free (with ads). Furthermore, at this step, the user may authorize access to any of the uploaded images to the listed friends.

Continuing to a step 232, the selected screensaver package is transmitted to the user. The user may then execute the package to load and install the screen saver application program

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A method comprising:
receiving, via network, a plurality of electronic images;
generating a screensaver application program that is configured to display the received electronic images; and
transmitting, via the network, the generated screensaver application program to a provider of the electronic images.

2. The method of claim 1, additionally comprising transmitting, via the network, a second generated screensaver to a recipient that is designated by the provider of the electronic images.

3. The method of claim 1, additionally comprising compressing the received electronic images at a server and prior to transmitting the generated screen application to the provider of the electronic images.

4. The method of claim 1, additionally comprising:
receiving from provider of the electronic images information identifying an email address of at least one individual other than the provider; and
automatically e-mailing a notice regarding the generated screensaver program to the identified email address.

5. The method of claim 1, additionally comprising generating package that includes the generated screensaver application program includes a single executable file that includes an application program and the compressed electronic images.

6. A system comprising:
an electronic device configured receive, via a network, a plurality of electronic images, the electronic device being further configured to generate a screensaver application program that is configured to display the received electronic images, and the electronic device being further configured to transmit, via the network, the generated screensaver application program to a provider of the electronic images.

7. The system of claim 6, wherein the electronic device is configured to transmit, via the network, a second generated screensaver to another requestor.

8. The system of claim 6, wherein the electronic device is configured to compress the received electronic images at a server and prior to transmitting the generated screen application to the provider of the electronic images.

9. The system of claim 6, wherein the electronic device maintains a plurality of libraries of compressed images, each of the libraries having associated authorization permissions for an individual or group of individuals

10. The system of claim 6, wherein the electronic device is configured to receive from the provider of the electronic images information identifying an email address of at least one individual other than the provider; and wherein the electronic device is configured to automatically email a notice regarding the generated screensaver program to the identified email address.

11. The system of claim 7, wherein generated screensaver application program includes a single executable file that includes an application program and the compressed electronic images.

12. A system comprising:
means for receiving, via network, a plurality of electronic images;
means for generating a screensaver application program that is configured to display the received electronic images; and
means for transmitting, via the network, the generated screensaver application program to a provider of the electronic images.

13. The system of claim 12, additionally comprising means for transmitting, via the network, a second generated screensaver to a recipient that is designated by the provider of the electronic images.

14. The system of claim 12, additionally comprising means for compressing the received electronic images at a server and prior to transmitting the generated screen application to the provider of the electronic images.

15. The system of claim 12, additionally comprising:
means for receiving from provider of the electronic images information identifying an email address of at least one individual other than the provider; and
means for automatically e-mailing a notice regarding the generated screensaver program to the identified email address.

16. The system of claim 12, wherein the generated screensaver application program includes a single executable file that includes an application program and the compressed electronic images.
